(19) United States
(12) Patent Application Publication
(10) Pub. No.: US 2014/0374195 A1
(43) Pub. Date: Dec. 25, 2014

(54) ROPE FOR LIFTING AND AN ELEVATOR COMPRISING THE ROPE

(71) Applicant: NV BEKAERT SA, 8550 Zwevegem (BE)

(72) Inventors: Jan Deconinck, Etterbeek (BE); Hendrik Rommel, Sint-Michiels (BE); Andreas Klust, Heverlee (BE); Dominique Lefebvre, Outrijve (BE)

(21) Appl. No.: 14/369,346

(22) PCT Filed: Dec. 7, 2012
(86) PCT No.: PCT/EP2012/074725

§ 371 Date: Jun. 27, 2014

(30) Foreign Application Priority Data
Jan. 5, 2012 (EP) 12150241.3

(51) Int. Cl. D07B 1/06; B66B 7/06; B66B 9/00

(52) U.S. Cl. CPC D07B 1/0633; D07B 1/0666; B66B 9/00; B66B 7/06
USPC 187/254; 57/214; 57/221

(57) ABSTRACT

A rope (210, 310) having a three-layered structure comprising a core layer, an inner layer and an outer layer, the core layer comprising one strand (225, 315), the inner layer comprising multiple strands (220) with an amount n and the outer layer comprising multiple strands (215) with an amount m, wherein n is an uneven number, and m is a number which has no common divisor with n, each strand is formed by multiple twisted metal filaments. By this structure fretting of the strands is reduced and the life time of the rope is improved. Also, the use of the rope in lifting application and an elevator system comprising such a rope are disclosed.

### TECHNICAL FIELD

The present invention relates to a rope. The rope comprises a core layer, an inner layer and an outer layer. The core layer comprises one strand, the inner layer comprises multiple strands and the outer layer comprises also multiple strands. The invention also relates to the application of such a rope in an elevator system and to an elevator system with such a rope.

### BACKGROUND ART

Multi-strand cords are well known in the general art of steel ropes and in the particular art of lifting.

US20080314016 discloses a rope for hoisting application. The rope performs well on strength and corrosion resistance, but it has a poor performance on fretting.

Another example of such a multi-strand rope is 1×19+8×7+8×19. This rope has proven its merits in the art of lifting. However, experience has shown that this cord may show fretting along some of its steel filaments with a reduced life time as a negative result.

### DISCLOSURE OF INVENTION

It is an object of the present invention to mitigate the drawbacks of the prior art.

It is another object of the present invention to provide a rope with an increased life time.

It is also an object of the present invention to provide a rope with a reduced degree of fretting.

According to a first aspect of the invention, there is provided a rope. This rope has a three-layer structure comprising a core layer, an inner layer and an outer layer. The core layer comprises one strand, the inner layer comprises a number of n strands and the outer layer comprises a number of m strands, n is an uneven number, and m is a number which has no common divisor with n. Each strand is formed by multiple twisted metal filaments.

According to the present invention, n strands of inner layer are twisted around the core layer and adjacent to the core layer; m strands of the outer layer are twisted around the inner layer and adjacent to the inner layer. ‘Adjacent’ means that there is no filament or strand in between.

The inventors have discovered that, to the existing metal rope with a three-layered structure, wherein the core layer has one strand and all the strands in the rope are formed by multiple twisted metal filaments, the reason of fretting and the resulting shortening of the life time is because somewhere along the length of the metal rope the load from the pulley to the metal rope is concentrated on one spot of the metal rope while applying the metal rope upon the pulley for lifting. At this critical spot some of the filaments of the metal rope form a line along each other resulting in point to point contacts from one side of the metal rope to the other side of the metal rope, which is so-called ‘filaments alignment phenomenon’. As a result, at the critical spot, only a few filaments carry the whole load and the load can't be distributed from these few filaments to the other remaining filaments, and these few filaments suffer from quite bigger load than the other remaining filaments, this critical spot becomes a weak spot. The limited load distribution causes fretting of the metal rope and a shortening of the life time of the metal rope.

Further analysis has led to the conclusion that such a critical spot can only occur in the three-layered metal ropes where the number of strands in the inner layer has a common divisor with the number of strands in the outer layer. So by carefully selecting the number of inner strands and the number of outer strands, alignment of the filaments at every spot along the length of the metal rope can be avoided. So the load from the pulley can be well distributed among the metal filaments in everywhere along the length of the metal rope, thereby reduce the fretting of the rope and improve the life time of the metal rope.

By avoiding that the number n of inner strands has a common divisor with the number m of outer strands, one excludes that somewhere along the length of the rope, all filaments get aligned. In other words, no filaments get aligned from one side of the rope to the other side of the rope everywhere along the length of the rope.

Examples of the multi-strand rope according to the first aspect of the invention are:
n is 3 and m is 4, 5, 7, 8, 10, 11, 13 or 14, so core+3+[4, 5, 7, 8, 10, 11, 13 or 14];
n is 5, and m is 4, 6, 7, 8, 9, 11, 12, 13 or 14, so core+5+[4, 6, 7, 8, 9, 11, 12, 13 or 14];
n is 7, and m is 4, 5, 6, 8, 9, 10, 11, 12, 13, 15, 16, 17, 18, 19 or 20, so core+7+[4, 5, 6, 8, 9, 10, 11, 12, 13, 15, 16, 17, 18, 19 or 20];
n is 9, and m is 4, 5, 7, 8, 10, 11, 13, 14, 16, 17, 19, 20, 22, 23 or 25, so core+9+[4, 5, 7, 8, 10, 11, 13, 14, 16, 17, 19, 20, 22, 23 or 25].

JP61-103458 discloses a synthetic resin rope, all the strands in the rope are consisting of synthetic resin fibers which have an average length of 5-200 μm and an average diameter of 0.1-5 μm.

CH122790 discloses a rope with a four-layered structure, the core layer in the rope is a fiber strand consisting of hemp fibers.

Because both the rope in JP61-103458 and the rope in CH122790 have fiber strand which is consisting of non-metal fibers with small length and diameter, the rope in JP61-103458 and the rope in CH122790 don't have the problem of ‘filaments alignment phenomenon’.

This principal feature of the invention can be combined with other measures to further decrease the amount of fretting and increase the life time of the rope.

Such measures may include the use of a polymer between the filaments. In this way the core layer may be covered with a first layer of a first polymer. The inner strands may be covered with a second layer of a second polymer. The outer strands may be covered with a third layer of a third polymer.

Preferably, this first, second or third polymer is polyurethane (PU), polyethylene (PE), thermal polyurethane (TPU), polytetrafluorethylene(PTFE), polypropylene(PP) and polystyrene(PS).

In a particular embodiment of the first aspect of the invention, the first polymer differs from the third polymer.

In another preferably embodiment, at least one strand in the rope is a round or compact round strand with multiple filaments. The compact round strand is one type of strand with a round cross-section and a compact structure while the spaces among the filaments are limited.

Preferably the round strand has a multiple layers structure, where the filaments in different layers have different diameters, i.e. a Warrington strand.

The rope according to the first aspect of the invention has multiple strands. Each strand has multiple metal filaments. The filaments may be steel filaments, for example, steel alloy filaments or high carbon steel filaments.

In a preferable embodiment, each strand consists of twisted metal filaments, e.g. twisted steel filaments. ‘Consist’ means other filaments are excluded.

According to the second aspect of the present invention, the rope according to the first aspect is applied for lifting elevator, crane or mining apparatus.

According to the third aspect of the present invention, there is provided an elevator system comprising a car, a counterweight, an elevator machine and ropes. The car and the counterweight are driven by the elevator machine via the ropes. At least one of the ropes has a three-layered structure comprises a core layer, an inner layer and an outer layer. The core layer comprises one strand, the inner layer comprises multiple strands with an amount n, the outer layer comprises multiple strands with an amount m, n is an uneven number, and m is a number which has no common divisor with n. The strands in the rope are formed by multiple twisted metal filaments.

### BRIEF DESCRIPTION OF FIGURES IN THE DRAWINGS

FIG. 1 shows a cross-sectional view of a prior-art steel rope.

FIG. 2 shows a cross-sectional view of a first preferred embodiment of the invention.

FIG. 3 shows a cross-sectional view of a second preferred embodiment of the invention.

FIG. 4 shows a front view of an elevator system.

### MODE(S) FOR CARRYING OUT THE INVENTION

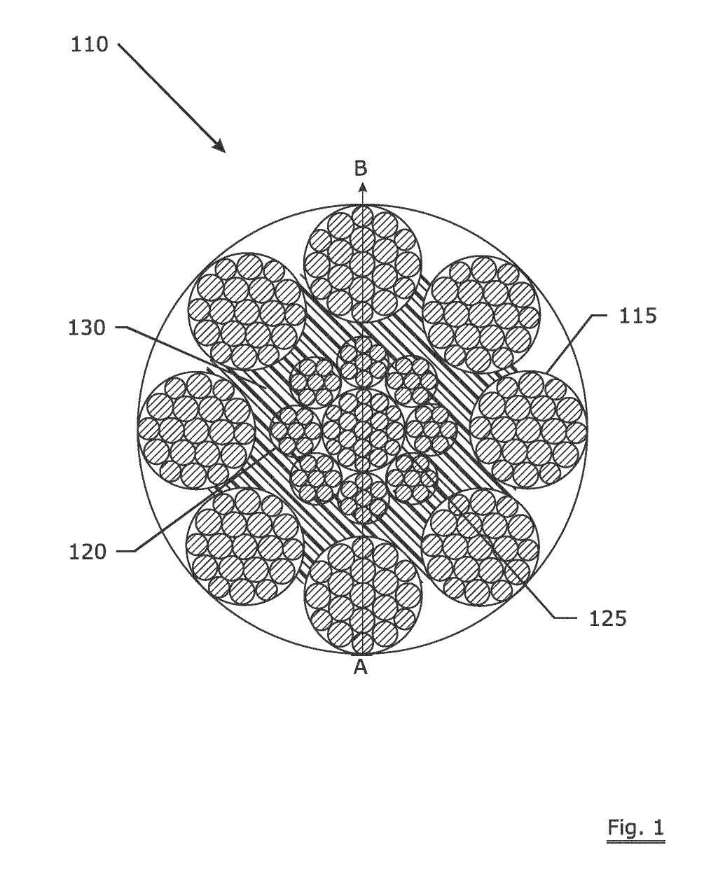

FIG. 1 illustrates a prior-art three-layered steel rope. The steel rope 110 has a core layer, an inner layer and an outer layer. The core layer comprises one strand 125 which is a Warrington strand having a structure of 1+6+12 (one filament as a core filament, 6 filaments twisted around the core filament and 12 filaments twisted around the 6 filaments). The inner layer comprises 8 strands 120 having a structure of 1+6. The outer layer comprises 8 Warrington strands 115 having a structure of 1+6+12. The 8 strands 120 are twisted to form the inner layer and the 8 strands 115 are twisted to form the outer layer. The steel rope 110 has a PU layer 130 surrounding the inner layer. While applying the rope 110 on lifting system, the rope 110 is put on a pulley to lift heavy load. The spot A of the rope 110 is the contact point between the rope 110 and the pulley. The load from the pulley to the rope 110 is concentrated on the spot A. At this critical spot A, a few filaments of the rope 110 form a line B along each other resulting in point to point contacts from one side of the rope 110 to the other side of the rope 110. As a result, only a few filaments in the line B carry the whole load while some other filaments have no chance to carry the load. This ‘filaments alignment phenomenon’ causes the fretting of the rope 110 and shortens the life time of the rope 110.

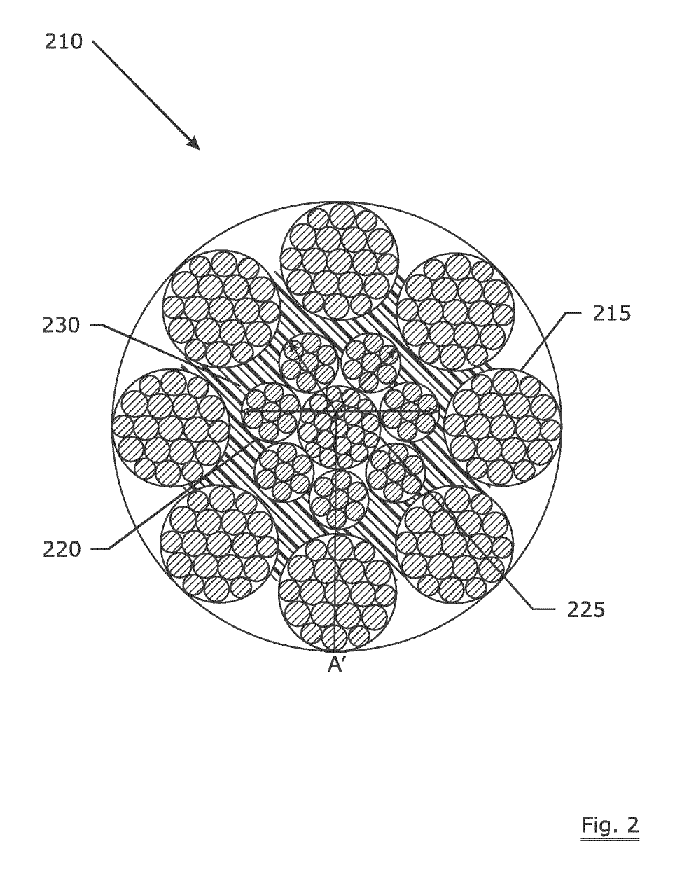

FIG. 2 illustrates a first embodiment of the present invention. The steel rope 210 has a core layer, an inner layer and an outer layer. The core layer comprises one strand 225 which is a Warrington strand having a structure of 1+6+12. The inner layer has 7 strands 220 with a structure of 1+6. The outer layer has 8 strands 215 with a structure of 1+6+12. The steel filaments in the strand have a carbon content of 0.70%. The steel rope has a PU layer 230 surrounding the inner layer. While applying the rope 110 on the pulley in a lifting system, the spot A′ of the rope 210 is the contact point between the rope 210 and the pulley. No filaments get aligned in everywhere along the length of the rope.

Compared with the prior-art rope 110, the load distribution from the spot A′ to the other side of the rope 210 isn't in a line, instead of only a few filaments carrying the load, more filaments in the rope 210 carry the load. This avoids the ‘filaments alignment phenomenon’ and reduces the fretting of the rope 210. As a result, the rope 210 has an increased life time compared with the rope 110.

To the present invention, the strands in inner layer are twisted with an inner twisting direction to form an inner layer. The strands in outer layer are twisted with an outer twisting direction to form an outer layer. The inner twisting direction and the outer twisting direction may be different or the same, i.e. the inner twisting direction is S while the outer twisting direction is Z or S, or the inner twisting direction is Z while the outer twisting direction is S or Z.

To the present invention, the core layer is covered by a first layer of a first polymer, and/or the inner layer is covered by a second layer of a second polymer, and/or the outer layer is covered by a third layer of a third polymer. The polymer in different layers may have the same or different material. Preferably these polymer layers are covered by extruding. One example of manufacturing method of the rope is, first, provide a core layer; then a first layer of PE is extruded on the core layer; then the strands are twisted to form an inner layer around the first layer; then a second layer of PE is extruded on the inner layer; then the strands are twisted to form an outer layer around the second layer; finally a third layer of PU is extruded on the outer layer.

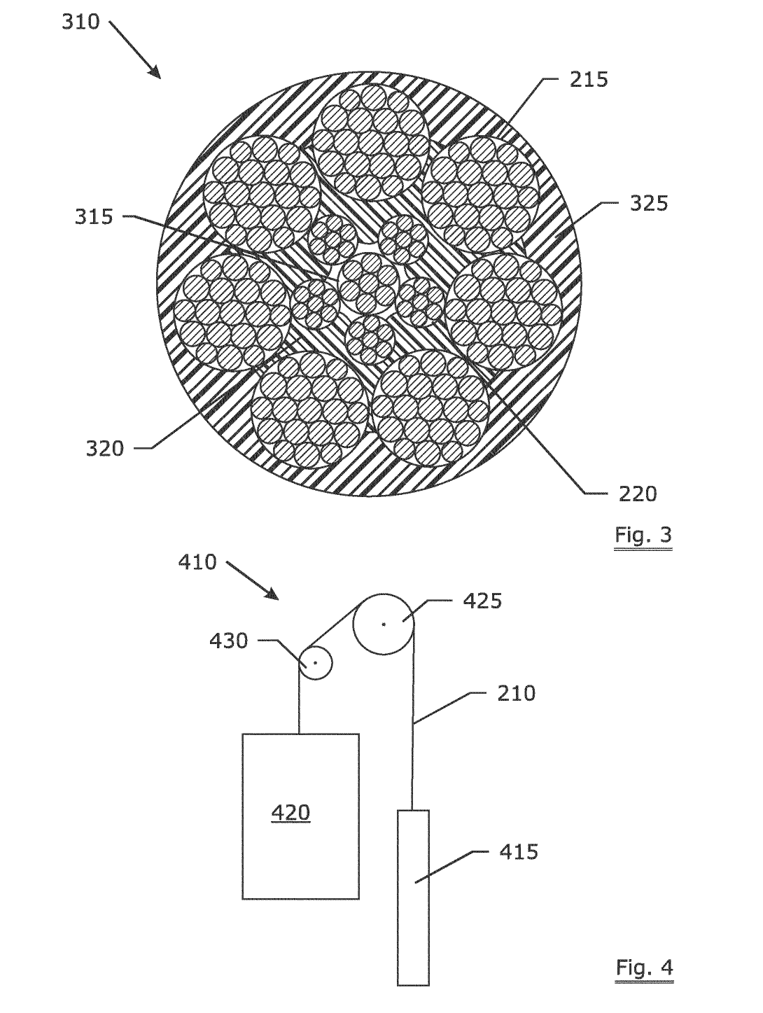

FIG. 3 illustrates a second embodiment of the present invention. The steel rope 310 has a core layer, an inner layer and an outer layer. The core layer comprises one strand 315 which has a structure of 1+6, the inner layer has 5 strands 220 and the outer layer has 7 strands 215. The rope 310 has a PU layer 325 surrounding the outer layer and a PE layer 320 surrounding the inner layer.

A third embodiment is a steel rope having a core layer comprising one strand with a structure of 1+6, an inner layer comprising 7 strands with a structure of 1+8 and an outer layer comprising 18 strands with a structure of 1+6+12.

A fourth embodiment is a steel rope having a core layer comprising one strand with a structure of 1+6, an inner layer comprising 3 strands with a structure of 1+8 and an outer layer comprising 13 strands with a structure of 1+8. The rope has a PU layer as a first layer surrounding the core layer.

A fifth embodiment is a steel rope having a core layer comprising one strand, an inner layer comprising 9 strands and an outer layer comprising 16 strands. The core strand is covered with a first layer of PE, the inner layer is covered with a second layer of PE and the outer layer is covered with a third layer of PU.

A sixth embodiment is a steel rope having a core layer comprising one strand, an inner layer comprising 5 strands and an outer layer comprising 12 strands. A TPU layer is covered on the outer layer.

FIG. 4 illustrates an embodiment of an elevator system. The elevator system 410 comprising a car 420, a counterweight 415, ropes 210 and the pulleys 425 and 430. The elevator system 410 also comprises an elevator machine which is not shown in this figure, i.e. a motor, providing the driving power. The car 420 and the counterweight 415 are driven by said elevator machine via the ropes 210.

1.-12. (canceled)

13. A rope having a three-layered structure comprising a core layer, an inner layer and an outer layer, said core layer comprising one strand, said inner layer comprising a number of n strands, said outer layer comprising a number of m strand, each strand is formed by multiple twisted metal filaments, characterized in that, said n is an uneven number, and said m is a number which has no common divisor with n.

14. A rope as claimed in claim 13, characterized in that said n is 3, while said m is 4, 5, 7, 8, 10, 11, 13 or 14.

15. A rope as claimed in claim 13, characterized in that said n is 5, while said m is 4, 6, 7, 8, 9, 11, 12, 13 or 14.

16. A rope as claimed in claim 13, characterized in that said n is 7, while said m is 4, 5, 6, 8, 9, 10, 11, 12, 13, 15, 16, 17, 18, 19 or 20.

17. A rope as claimed in claim 13, characterized in that said n is 9, while said m is 4, 5, 7, 8, 10, 11, 13, 14, 16, 17, 19, 20, 22, 23 or 25.

18. A rope as claimed in claim 13, characterized in that said core layer is covered by a first layer of a first polymer and/or said inner layer is covered by a second layer of a second polymer and/or said outer layer is covered by a third layer of a third polymer.

19. A rope as claimed in claim 18, characterized in that said first polymer is different from said third polymer.

20. A rope as claimed in claim 18, characterized in that said first polymer, said second polymer or said third polymer is polyurethane or polyethylene.

21. A rope as claimed in claim 13, characterized in that at least one strand in the rope is a compact round strand comprising multiple filaments.

22. A rope as claimed in claim 21, characterized in that said strand has a multiple layers structure, said filaments in different layers have different diameters.

23. Use of a rope as claimed in claim 13 is for lifting elevator, crane or mining apparatus.

24. An elevator system comprising a car, a counterweight, an elevator machine and ropes, said car and said counterweight being driven by said elevator machine via said ropes, at least one said rope having a three-layered structure comprising a core layer, an inner layer and an outer layer, said core layer comprising one strand, said inner layer comprising multiple strands with an amount n, said outer layer comprising multiple strands with an amount m, each strand is formed by multiple twisted metal filaments, characterized in that, said n is an uneven number, and said m is a number which has no common divisor with n.
